(19) United States
(12) Patent Application Publication
(10) Pub. No.: US 2008/0215576 A1
(43) Pub. Date: Sep. 4, 2008

(54) FUSION AND VISUALIZATION FOR MULTIPLE ANOMALY DETECTION SYSTEMS

(75) Inventors: Ying Zhao, Cupertino, CA (US); Charles Chuxin Zhou, Cupertino, CA (US); Chetan K. Kotak, San Jose, CA (US)

Correspondence Address: Charles C. Zhou;Ying Zhao, 3375 SCOTT BLVD, SUITE 100, SANTA CLARA, CA, 95054, US

(73) Assignee: QUANTUM INTELLIGENCE, INC., SANTA CLARA, CA (US)

(21) Appl. No.: 12/042,338

(22) Filed: Mar. 5, 2008

(51) Int. Cl. G06F 17/30

(52) U.S. Cl. 707/5; 707/E17.061

(57) ABSTRACT

The present invention is a method for detecting anomalies against normal profiles and for fusing and visualizing the results from multiple anomaly detection systems in a quantifying and unifying user interface. The knowledge patterns discovered from historical data serve as the normal profiles, or baselines or references (hereinafter, called “normal profiles”). The method assesses a piece of information against a collection of the normal profiles and decides how anomalous it is. The normal profiles are calculated from historical data sources, and stored in a collection of mining models. Multiple anomaly detection systems generate a collection of mining models using multiple data sources. When a piece of information is newly observed, the method measures the degree of correlation between the observed information and the normal profiles. The analysis is expressed and visualized through anomaly scores and critical event notifications that are triggered by fusion rules, thus allowing a user to see multiple levels of complexity and detail in a single view.

### CROSS-REFERENCE TO RELATED APPLICATIONS

N/A

### FEDERALLY SPONSORED RESEARCH

N/A

### SEQUENCE LISTING

NONE

### REFERENCES

S. Rubin, M. Christodorescu, V. Ganapathy, J. T. Giffin, L. Kruger, H. Wang and N. Kidd. “An Auctioning Reputation System Based on Anomaly Detection”. In ACM CCS'05, Nov. 7-11, 2005.
[2] P. Varner and J. C. Knight, “Security Monitoring, Visualization, and System Survivability”, Information Survivability Workshop, January 2001.
[3] M. Luis, A. Bettencourt, R. M. Ribeiro, G. Chowell, T. Lant and C. Castillo-Chavez, “Towards Real Time Epidemiology: Data Assimilation, Modeling and Anomaly Detection of Health Surveillance Data Streams”, Lecture Notes in Computer Science, Springer Berlin/Heidelberg, 2007
[4] R. K. Gopal, and S. K. Meher, “A Rule-based Approach for Anomaly Detection in Subscriber Usage Pattern”, International Journal of Mathematical, Physical and Engineering Sciences. Volume 1 Number 3.
[5] S. Sarah, “Competitive Overview of Statistical Anomaly Detection”, White Paper, Juniper Networks, 2004
[6] P. Laskov, K. Rieck, C. Schäfer, K. R. Miller, “Visualization of Anomaly Detection Using Prediction Sensitivity”, Proc. of Sicherheit, April 2005, P. 197-208.
[7] K. Labib, V. R. Vemuri, “Anomaly Detection Using S Language Framework: Clustering and Visualization of Intrusive Attacks on Computer Systems”. Fourth Conference on Security and Network Architectures, SAR'05, Batz sur Mer, France, June 2005
[8] F. Mizoguchi, “Anomaly detection using visualization and machine learning”, Proceedings of IEEE 9th International Workshops on Enabling Technologies: Infrastructure for Collaborative Enterprises, 2000 P 165-170.
[9] X. Zhang, C. Gu, and J. Lin, “Support Vector Machines for Anomaly Detection”, The Sixth World Congress on Intelligent Control and Automation, P 2594-2598, 2006.
[10] C. Krügel, T. Toth, “Applying Mobile Agent Technology. to Intrusion Detection”, ICSE Workshop on Software Engineering and Mobility, Toronto May 2001

### BACKGROUND OF INVENTION

1. Field of Invention

The invention relates to a dynamic anomaly analysis of both structured and unstructured information. This invention also relates to the visualization of the analysis through anomaly scores from multiple anomaly detection systems and from critical event notifications triggered by fusion rules.

2. Related Art

Anomaly detection refers to identifying cases (records) that deviate from the norm in a dataset. Anomaly detection has been applied to many diversified fields, for example, fraud detection[1], intrusion detection in a computer network[2] and early event detection when monitoring health surveillance data streams[3]. An anomaly detection system typically requires historical data provided for a model building process that is able to extract normal profiles (Hereinafter, normal profiles also mean knowledge patterns, baselines or references) from which an anomaly detection is based upon. Applying the model to new data with similar schema and attribute content yields a probability that each case is normal or anomalous. Traditional methods include rule-based expert systems [4] to detect known system anomalies or on statistical anomaly detection to detect deviations from normal system activity[5].

Combining visual and automated data mining for anomaly detection is a new trend of the current art, for example, visualization combined using prediction sensitivity [6], clustering[7], machine learning[8], support vector machine [9], and mobile agent technologies [10].

Most of these systems worked well in a simulated environment; however, because anomalies in real-life are so sophisticated and evolve very rapidly, there are few deployable systems. The real challenge of anomaly detection is not increasing sensitivity to anomalies, but decreasing the number of false positives.

### SUMMARY OF THE INVENTION

The current anomaly detection systems tend to identify all possible anomalies instead of only the real anomalies. In other words, those systems usually have high false alarm rates. A high false alarm rate is the limiting factor for the performance of those anomaly systems. A solution to this problem lies in the application and visualization of data fusion techniques to aggregate multiple anomaly detection results into a single view and cross-validate to reduce the false alarm rates. The invention addresses this issue by using fusion rules and visualization techniques to combine the results from multiple anomaly detection systems. Fusion rules are decision support rules to fuse or combine anomaly detection results from multiple systems.

The invention allows for the analysis and quantification of information as it relates to a collection of normal profiles. More specifically, the invention allows information to be measured in terms of the level of anomaly with respect to multiple normal profiles. Normal profiles are knowledge patterns discovered from historical data sources. This measure or anomaly score is visualized in meters that allow for easy interpretation and updating. The method fuses the anomaly results from multiple detection systems and displays this data such that a human viewer can understand the real meaning of the results and quickly comprehend genuine anomaly activities. Furthermore, an analysis of information is accomplished through critical event notifications. Anomalies from separate systems are processed and evaluated against fusion rules, which trigger notification and visualization of only real anomaly events.

In the aspect of the invention, a method is provided for assessing a piece of information against normal profiles and deciding a level of anomalies, including:
Generating normal profiles from historical data sources
Storing the normal profiles in a collection of mining models
Comparing the information against the normal profiles
Generating anomaly scores
Triggering fusion rules
Displaying and categorizing critical events

Additional aspects of the invention, applications and advantages will be detailed in the following descriptions.

### BRIEF DESCRIPTION OF THE FIGURES/DRAWINGS

FIG. 1 is a flowchart describing the steps involved in analyzing and visualizing information for anomalies.

FIG. 2 is a block diagram representing a single anomaly detection system.

FIG. 3 is a diagram showing a network of anomaly detection systems.

FIG. 4 is a flowchart describing the steps taken by the critical event engine when evaluating an anomaly for critical events.

FIG. 5 is an illustration of the user interface for the present invention.

FIG. 6 is an illustration of one incarnation of an anomaly score visualization.

FIG. 7 is an illustration of one incarnation of a critical event visualization.

### DETAILED DESCRIPTION OF THE INVENTION

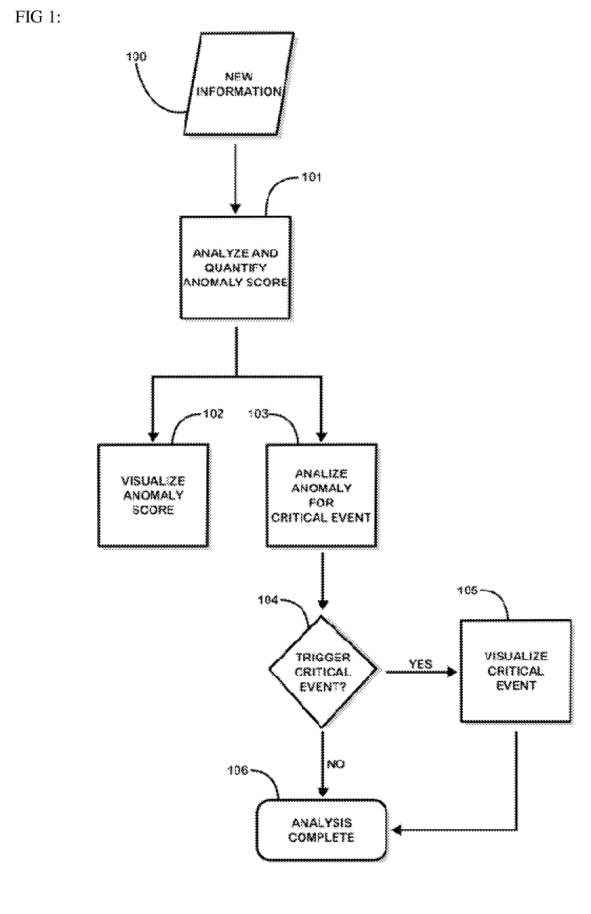

The present invention is used to analyze and assess information against how anomalous it is. The invention then allows for the assessment to be visualized through a user interface. FIG. 1 represents a flowchart diagram of the steps and processes involved in anomaly detection and visualization within a single anomaly detection system. New information 100 represents any form of structured and unstructured text and data that is to be processed by the system. The new information is passed to the anomaly detection engine, where it will be analyzed and the anomaly score will be determined 101. Upon completion, the score is wrapped in a meter object and is passed to the user interface for visualization 102. The anomaly score is further analyzed by the critical event engine to determine if any fusion rules have been triggered 103, 104. If a rule has been triggered, a critical event object is created and passed to the user interface for visualization 105. Finally, the process is complete 106.

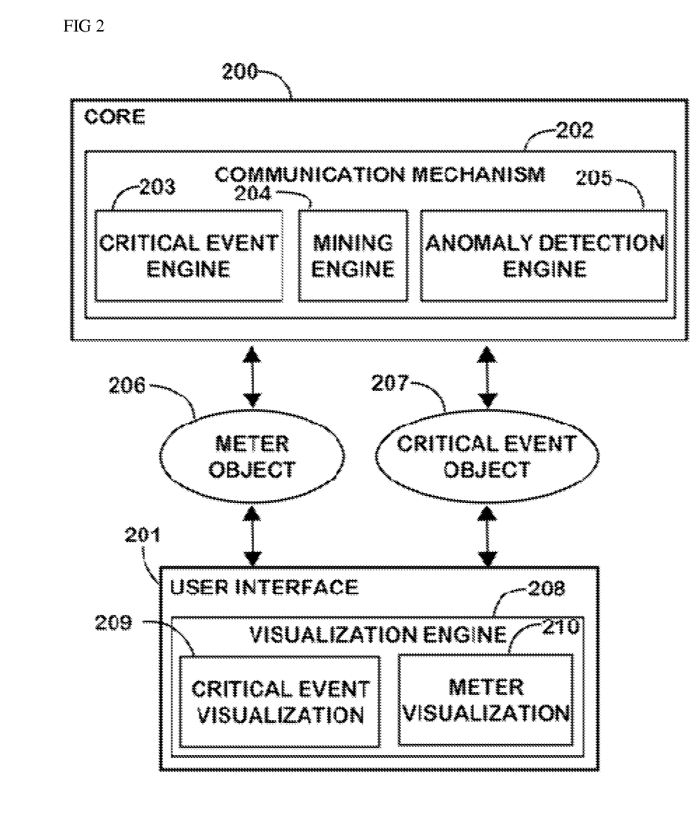

FIG. 2 is a block diagram representing a single anomaly detection system. The anomaly detection system is separated between the core 200 component and the user interface 201 component. The core component is responsible for the analysis and communication involved in determining the anomaly score of new information and for assessing whether or not information has triggered a critical event. All interactions between the core component and any other anomaly detection system is handled through a communication mechanism 202. Data passed to and from the anomaly detection system is encoded and decoded by the communication mechanism and then delegated to the proper component or to other anomaly detection systems.

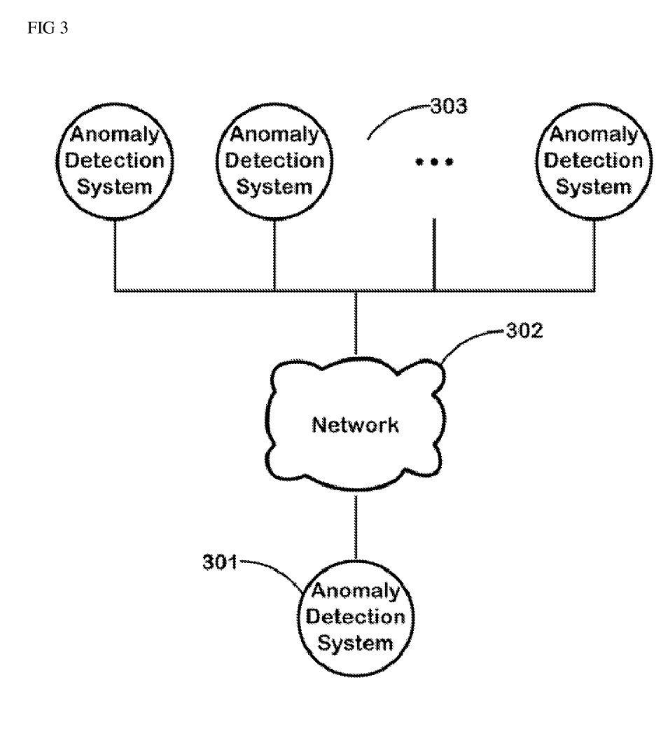

Multiple anomaly detection systems can be put on a network in order to assess new information against multiple normal profiles created by multiple data sources. Anomaly scores are fused from all anomaly detection systems on the network and applied against the fusion rules. FIG. 3 is a diagram of a network containing multiple anomaly detection systems. A source anomaly detection system 301 contacts multiple anomaly detection systems 303 across a network 302.

The mining engine 204 in FIG. 2 is responsible for the advanced data and text mining capabilities used in the anomaly detection system. This allows for the implementation of a single anomaly detection system that is trained from one data source and creates normal profiles. The anomaly detection system discovers normal knowledge patterns from its local domain and historical data. The discovered knowledge patterns are then stored locally in a mining model. These normal profiles are shared across multiple detection systems.

Application of the mining model and assessment of a piece of new information is handled by the anomaly detection engine 205. The new information is parsed and processed, where it can then be scored with an anomaly value. The anomaly value is a decimal number representing the degree of correlation the new information has to the normal profiles contained in the mining model. The score values range between 0 and 100, where a score of 0 indicates total unfamiliarity and 100 indicates total familiarity. Thus, a score of 0 can be interpreted as being an anomaly versus the normal profile. These anomaly score values are then placed into data objects called meter objects 206. Meter objects allow for anomaly scores to be represented structurally, providing a way for other components (e.g. the user interface) to interpret or visualize it.

Anomaly scores from the anomaly detection engine and from multiple detection systems are processed by the critical event engine 203. These scores are evaluated against a set of domain specific fusion rules. Fusion rules are expert rules for interpreting detection results from multiple systems. These rules can be set up to look for specific patterns and groupings, thus triggering critical event notifications, for example, a credit fraud event is notified when a large amount of charges occur in a short time frame. The critical event engine places the events in objects called critical event objects 207. Critical event objects allow for triggered events to be represented structurally, providing a way for other components (e.g. the user interface) to interpret or visualize it.

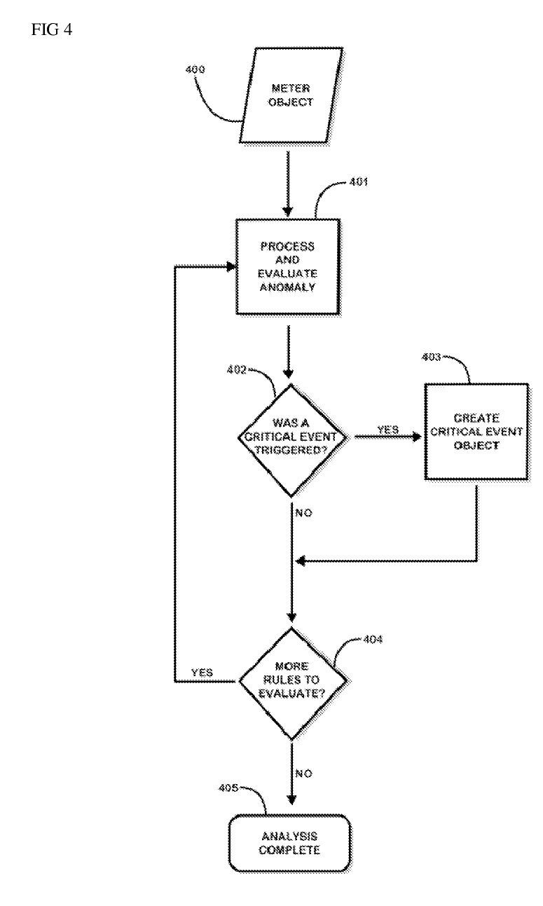

FIG. 4 is a flowchart representing the steps taken by the critical event engine when evaluating anomaly scores against the fusion rules. Meter objects 400 created by the anomaly detection engine and retrieved from other anomaly detection systems are processed and evaluated 401. A single fusion rule is tested to see if a critical event is triggered 402. If an event was triggered, a critical event object 403 is created in order to pass to the user interface or other components. As there may be multiple fusion rules available for evaluation, the engine checks to see if there are more rules left to evaluate 404. Once all the rules have been evaluated against the current anomaly scores, the process completes 405.

The meter object and the critical event object are data structures used to hold information representing the anomaly score and the critical event respectively. At a minimum, the meter object contains a reference to the information this meter object references and the calculated anomaly score. The anomaly detection engine creates the meter object for consumption by other components. At a minimum, a critical event object contains a reference to the information this critical event object references and the name of the critical event rule that was triggered. The data structures of both objects can be modified to accommodate the need for more detail.

All communication between the user interface 201 component and any other components in FIG. 2 is handled through the visualization engine 208. The visualization engine understands how to process data objects and to which components it needs to delegate visualization. The meter visualization 210 component handles the presentation of meter objects 206 to the user interface. The critical event visualization 209 component handles the presentation of critical event objects 207 to the user interface.

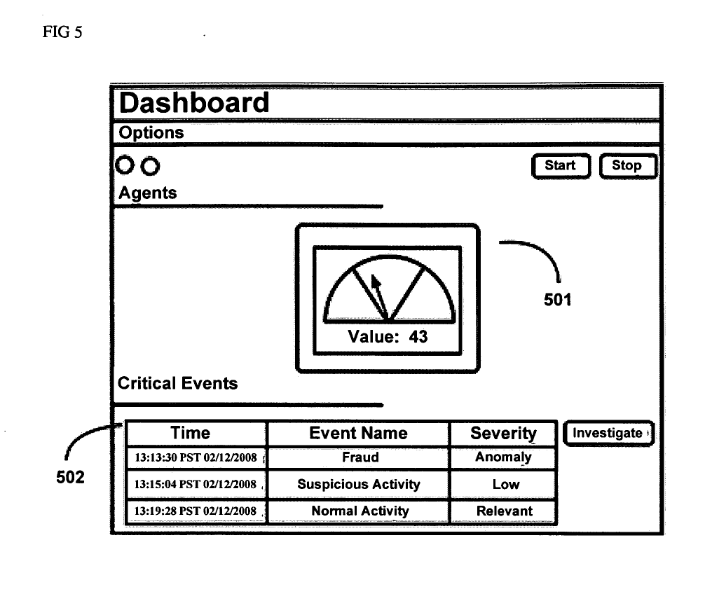

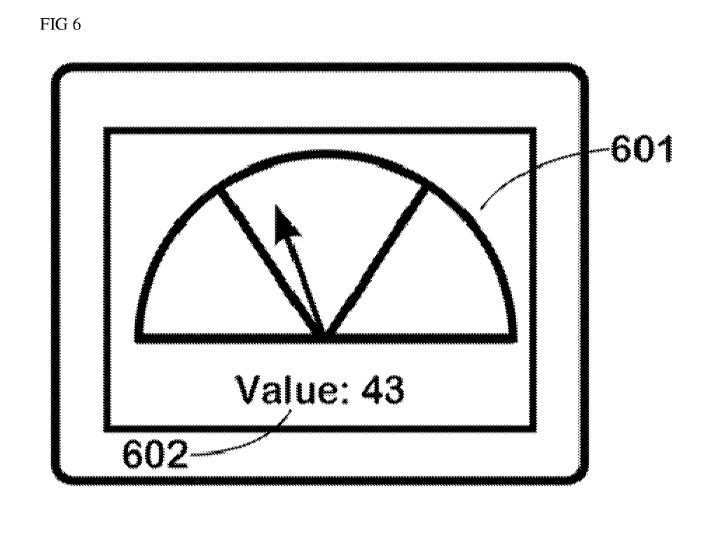

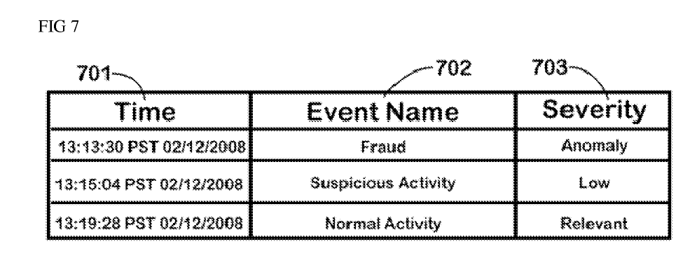

FIG. 5 illustrates one version of the user interface used to visualize anomalies. The interface includes two main sections: visualization of meter objects 501 and visualization of critical event objects 502. FIG. 6 is a detailed illustration of the visualization of a meter object. A gauge 601, 602 is used to visually represent the anomaly score of new information from an anomaly detection system. FIG. 7 is a detailed illustration of the visualization of a critical event object. Critical event notifications are displayed in a table structure, allowing for all events triggered by fusion rules to be explored. Detailed information of critical events, such as the time the rule was triggered 701, the critical event name 702, the severity or categorization of the critical event 703, and any other information stored in the critical event object can be displayed for analysis.

What is claimed:

1. A method of assessing a piece of information against normal profiles and deciding how anomalous it is including generating normal profiles from historical data sources, storing the normal profiles in a collection of mining models, comparing the information against the normal profiles, generating anomaly scores, triggering fusion rules and displaying and categorizing critical events.

2. A method of claim 1, wherein generating normal profiles including mining historical data from a local data and knowledge repository with structured and unstructured data sources and discovering knowledge patterns with respect to local data sources. Structured data sources include, for example, data from excel spreadsheets, databases and XML data. Unstructured data sources include, for example, free text input, word, html, pdf and ppt documents.

3. A method of storing the discovered knowledge patterns within a collection of mining models.

4. A method of claim 3, wherein sharing mining models involving forming a network by multiple anomaly detection systems which contain the mining models

5. A method of assessing a piece of information including comparing it against the normal profiles said in claim 1 and determining an anomaly score.

6. A method of claim 5, wherein comparing a piece of information with the normal profiles said in claim 2 including calculating the degree of the association or correlation the new information with the normal profiles.

7. A method of claim 5, wherein assessing a piece of information including calculating an anomaly score for a piece of real-time information from, for example, a search interface, a real-time data feed or a data subscription.

8. A method of representing anomaly scores as a decimal number ranging between 0 and 100

9. A method of representing anomaly scores structurally easily for interpreting and visualizing the scores.

10. A method of claim 9 wherein interpreting, fusing and visualizing anomaly scores to trigger a critical event.

11. A method of claim 10 wherein triggering a critical event including processing the multiple anomaly scores and deciding which fusion rule is triggered.

12. A method of claim 11, wherein deciding fusion rules among multiple anomaly detection systems including deciding domain specific fusion rules and setting fusion rules to look for specific patterns and groupings.

13. A process of evaluating anomalies among multiple systems including evaluating against a single fusion rule and multiple fusion rules sequentially.

14. A method of creating a critical event object and passing it to a user interface for visualization when fusion rules said in claim 12 are trigged.

15. A method of categorizing critical events based on fusion rules

16. A method of holding the information (e.g. data structure) representing the anomaly score of a piece of information said in claim 5 containing at least a reference to the information and the calculated anomaly score.

17. A method of holding information (e.g. data structure) representing a critical event said in claim 10 triggered by assessing of a piece of information containing at least a reference to the information and a fusion rule that is triggered.

18. A method of modifying and accommodating more detail of holding information said in claim 17.

19. A method of visualizing and understanding anomalies including handling the presentation of anomaly scores and the presentation of critical events to a user interface.

20. A method of displaying critical events and allowing for all triggered fusion rules to be explored, involving, for example, the time a fusion rule is triggered, the critical event name, and the severity or categorization of the critical event.

21. A computer program that stores instructions executable by one or more processors to perform a method of assessing a piece of information, deciding how anomalous it is including generating normal profiles from historical data sources, storing the normal profiles in a collection of mining models, comparing the information against the normal profiles, generating anomaly scores, triggering fusion rules and displaying and categorizing critical events.

22. A computer program that stores instructions executable by one or more processors to perform a method of assessing a real-time flow of new information, for example, from a search interface, real-time data feed and subscription deciding how anomalous it is including generating normal profiles from historical data sources, storing the normal profiles in a collection of mining models, comparing the information against the normal profiles, generating anomaly scores, triggering fusion rules and displaying and categorizing critical events.
